(19) United States
(12) Patent Application Publication
(10) Pub. No.: US 2017/0206068 A1
(43) Pub. Date: Jul. 20, 2017

(54) PROGRAM OPTIMIZATION BASED ON DIRECTIVES FOR INTERMEDIATE CODE

(71) Applicant: Cray Inc., Seattle, WA (US)

(72) Inventors: Brian H. Johnson, Chippewa Falls, WI (US); Heidi Poxon, Chippewa Falls, WI (US); Luiz DeRose, Mendota Heights, MN (US); Gary W. Elsesser, Eagan, MN (US); Clayton D. Andreasen, Rosemont, MN (US); John Levesque, Knoxville, TN (US)

(21) Appl. No.: 15/149,347

(22) Filed: May 9, 2016

Related U.S. Application Data
(60) Provisional application No. 62/280,584, filed on Jan. 19, 2016.

(51) Int. Cl. G06F 9/45

(52) U.S. Cl. CPC G06F 8/443

(57) ABSTRACT

An optimization system to apply directives to a computer program without having to perform repeated front-end compilations of source code of the computer program is provided. In some embodiments, the optimization system performs a first compilation of the source code of the program to generate first front-end code and first back-end code of the computer program. The compilation includes a first front-end compilation and a first back-end compilation. The optimization system identifies a compiler directive to apply to a location within the first front-end code. The optimization system then performs a second back-end compilation of the first front-end code factoring in the compiler directive to generate second back-end code affected by the compiler directive.

### CROSS-REFERENCE TO RELATED APPLICATION(S)

This application claims the benefit of U.S. Provisional Patent Application No. 62/280,584 filed Jan. 19, 2016, entitled “PROGRAM OPTIMIZATION BASED ON DIRECTIVES FOR INTERMEDIATE CODE,” which is incorporated herein by reference in its entirety.

### BACKGROUND

The architectures of High Performance Computer (“HPC”) systems are supporting increasing levels of parallelism in part because of advances in processor technology. An HPC system may have thousands of nodes with each node having 32, 64, or even more processors (e.g., cores). In addition, each processor may have hardware support for a large number of threads. The nodes may also have accelerators such as graphic processor units (GPUs) and single instruction/multiple data (SIMD) units that provide support for multithreading and vectorization.

Current computer programs are typically developed to use a single level of parallelism. As a result, these computer programs cannot take advantage of the increasing numbers of cores and threads. These computer programs will need to be converted to take advantage of more computing resources by adding additional levels of parallelism. Because of the complexities of the architectures of such HPC systems and because of the increasing complexity of computer programs, it can be a challenge to convert existing, or even develop new, computer programs that take advantage of the high level of parallelism. Although significant advances in compiler technology have been made in support of increased parallelism, compilers still depend in large part on programmers to provide compiler directives to help the compilers determine which portions of a program can be parallelized. Similarly, because of these increased complexities in the architectures and computer programs, programmers can find it challenging to generate code to take advantage of such parallelism or to even determine what directives would be effective at guiding a compiler. An incorrect directive or incorrect decision made by a compiler may result in a compiled program with the wrong behavior, which can be very difficult to detect and correct. Moreover, it can be difficult to even determine whether such complex computer programs are behaving correctly.

During development of a computer program, a programmer may decide to change a directive, for example, because of a wrong behavior that was observed during execution of the computer program or to add a directive to parallelize regions of code to improve performance of the computer program. After modifying the source code to change or add directives, the programmer recompiles the source code modules of the computer program and relinks the object code modules of the computer program to generate new executable code (e.g., an executable file) for the computer program. After generating the executable code, a programmer then runs the computer program (i.e., executes the executable code) and analyzes the performance of the computer program.

The compiling and linking of a computer program is typically divided into several phases. The compilation of a computer program may involve a front-end compilation phase and a back-end compilation phase. During a typical front-end compilation phase, a compiler inputs the source code, performs syntactic analysis (e.g., lexical analysis and parsing) and semantic analysis of the source code, and then outputs front-end code, also referred to as intermediate code. During a typical back-end compilation phase, the compiler inputs the front-end code, performs inter-procedural analyses, optimizations, and code generation, and then outputs back-end code. The back-end code is generally assembly code. In a generate-executable phase, an assembler assembles the assembly code into object code and a linker links the object code to generate the executable code. Although compilers typically output assembly code, some compilers may output object code rather than assembly code.

It can be a challenge for a programmer to identify the set of directives (e.g., parallelization directives, vectorization directives, and inlining directives) that will result in the optimal, or even acceptable, performance of a complex computer program. Complex computer programs may include hundreds or even thousands of source code modules that may each contain hundreds of lines of source code. Because of the complexity of a computer program, it can be difficult to understand the effects of a particular set of directives. To help understand the effects, a programmer may need to analyze performance data (e.g., loop size, loop trip count, and array size) on hundreds of optimization candidates, data-sharing attributes of thousands of variables, a call graph with hundreds of routines, and so on. Even more important than ensuring acceptable performance, a programmer needs to ensure that the directives will not result in incorrect behavior of the computer program, for example, as a result of an incorrect data-sharing attribute.

In an effort to identify an optimal set of directives, programmers often will iteratively experiment with different sets of directives until the desired performance is achieved. For each set of directives (or experiment), a programmer modifies the source code to include the directives, recompiles and relinks to generate executable code, executes the executable code to collect performance data, and determines whether to repeat the process with a new set of directives based on analysis of the performance data. Since the process of modifying the source code and recompiling the source code can be time-consuming and computationally intensive for complex computer programs, programmers may not perform comprehensive experimenting with different sets of directives to identify the set that would result in the optimal performance of the computer program. The executing of computer programs with less than optimal performance may have serious consequences such as not being able to generate results in a timely manner, requiring additional costly hardware resources, and so on.

### BRIEF DESCRIPTION OF THE DRAWINGS

FIG. 1 is a block diagram that illustrates components of a compiler.

FIG. 2 is a block diagram that illustrates more detailed components of a compiler.

FIG. 3 is a block diagram that illustrates components of an optimization system in some embodiments of the optimization system.

FIG. 4 is a flow diagram that illustrates the processing of a component that controls the generating of back-end directives in some embodiments of the optimization system.

FIG. 5 is a diagram illustrating a representation of a parallel directive in some embodiments of the optimization system.

FIG. 6 is a diagram illustrating a representation of a do directive in some embodiments of the optimization system.

FIG. 7 is a block diagram that illustrates components of the optimization system in some embodiments.

FIG. 8 is a flow diagram that illustrates processing of a controller in some embodiments of the optimization system.

FIG. 9 is a flow diagram that illustrates overall processing of a component to generate performance-based directives in some embodiments of the optimization system.

FIG. 10 is a flow diagram that illustrates the processing of a component to create directives in some embodiments of the optimization system.

FIG. 11 is a flow diagram that illustrates the processing of a component to create a directive in some embodiments of the optimization system.

FIG. 12 is a flow diagram that illustrates the processing of a component to create do directives in some embodiments of the optimization system.

FIG. 13 is a flow diagram that illustrates processing of a component to generate back-end directives in some embodiments of the optimization system.

### DETAILED DESCRIPTION

A method and system for optimizing a computer program is provided. In some embodiments, an optimization system supports the specifying of directives based on intermediate code generated by a compiler, rather than based on source code of a computer program. The optimization system initially directs or controls a first compilation of source code of a computer program to generate first front-end code and first back-end code of the program. The optimization system then determines one or more directives for optimization of the computer program and the locations within the computer program to which the directives are to be applied. For example, the optimization system may determine a directive and its location by receiving from a user an indication of the directive and the location or by analyzing performance data (e.g., trip counts) collected during execution of the computer program. The optimization system augments the first front-end code with the directives. The optimization system then directs or controls the performing of a second back-end compilation of the first front-end code, factoring in the directives to generate second back-end code. The executable code is then generated from the second back-end code. Because the optimization system augments the front-end code with the directives, rather than adding the directives to the source code, a second front-end compilation of the source code with the added directives can be avoided. As a result, the determining of different directives, the performing of the back-end compilation phase, the generating of the executable code, and the executing of the executable code can be performed any number of times with different directives without having to regenerate the front-end code. Considerable time and computational resources can be saved because the modification of the source code and the front-end compilation phase can be avoided when experimenting with different directives. Once a programmer is satisfied with the performance of the computer program, the optimization system may automatically add the directive to the source code.

In some embodiments, the optimization system may automatically identify directives for a computer program. To do so, the optimization system may direct the compiling and executing of the computer program to collect performance data for the computer program. The performance data may be collected by instrumenting the source code of the computer program, by debugging code, by hardware counters, and so on. Since knowledge of data-sharing attributes of variables of a computer program is important for optimizing the computer program, the optimization system may automatically identify data-sharing attributes (e.g., shared and private) of variables of the computer program. Techniques for identifying data-sharing attributes of variables are described in U.S. Pat. No. 9,250,877, entitled “Assisting Parallelization of a Computer Program,” filed on Sep. 20, 2013 and issued on Feb. 2, 2016, which is hereby incorporated by reference. The optimization system analyzes the performance data and the computer program to identify directives for the computer program. When identifying the directives, the optimization factors in the architecture (e.g., number of cores and thread processing units), execution time of regions of code, trip counts of loops, the overhead incurred by optimizing (e.g., time to set up a loop for parallelization), and so on. For example, if a processor can support 32 threads executing simultaneously, but the trip count for a loop is only four, the overhead of creating four threads may be higher than the benefit of executing iterations of the loop in parallel. As another example, if the trip count is 256, but the loop consists of only 10 instructions, the overhead of parallelization again may outweigh any benefit. After identifying the directives, the optimization system may augment the front-end code with the directives either with or without programmer review. For programmer review, the optimization system may present to the programmer an indication of each directive along with its corresponding location in the source code (e.g., module name and line number) even though the directives are not added to the source code. The optimization system may also allow the programmer to designate additional directives. The optimization system may provide various optimization parameters that a programmer can set to control the level of optimization. For example, one optimization parameter may be the minimum trip count of a loop that is needed for parallelization (e.g., only parallelize if trip count is 32 or greater). Another optimization parameter may be the minimum average execution time of iteration of a loop that is needed to parallelize a loop. By allowing the programmer to set the level of optimization and automatically identifying directives without having to regenerate the front-end code as the level changes, the optimization system allows the programmer to rapidly evaluate the different levels of optimization (e.g., experiments) and select the desired set of directives for the computer program.

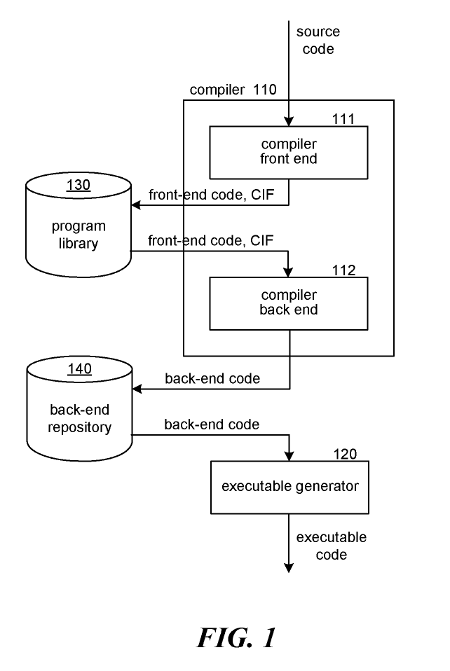

FIG. 1 is a block diagram that illustrates components of a compiler. The compiler 110 includes a compiler front end 111 and a compiler back end 112. The compiler front end inputs source code and performs syntactic and lexical analysis to generate front-end code. The compiler front end stores the front-end code along with compiler information (“CIF”) in a program library 130. The compiler information includes a mapping of the source code to the corresponding front-end code. For example, the compiler information may include a loop identifier for each loop that maps to the start and end locations of the loop in the source code. The compiler information may also include information specifying the directives of the source code and corresponding location in the front-end code. The compiler back end inputs the front-end code and the compiler information from the program library and generates back-end code that is stored in a back-end repository 140. The back-end code may be assembly code or object code. An executable generator 120 inputs the back-end code and generates the corresponding executable code.

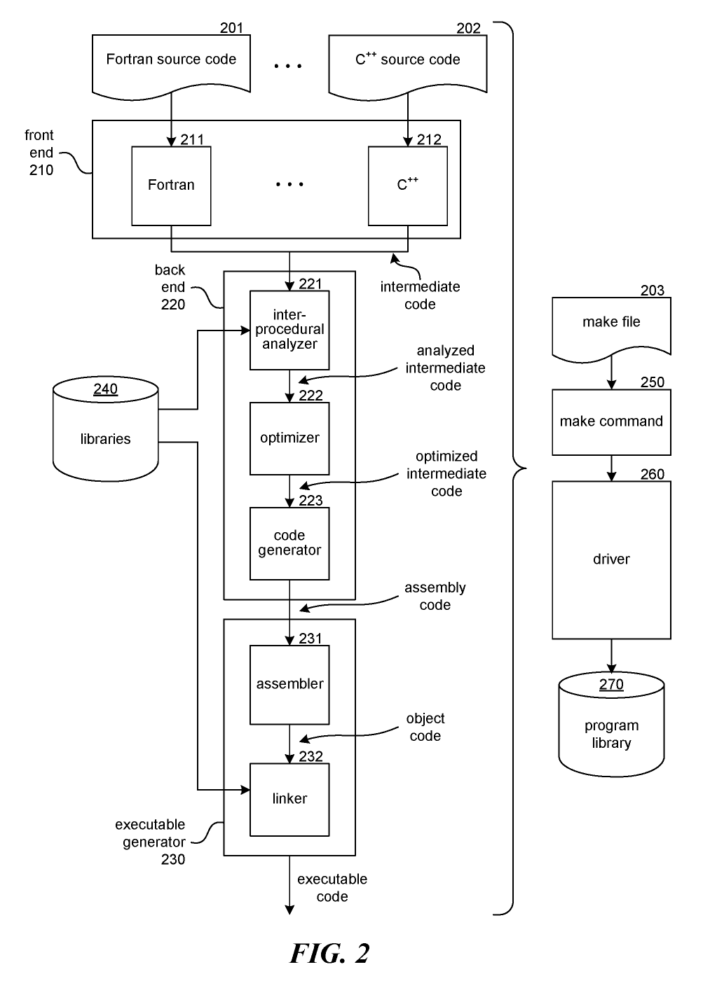

FIG. 2 is a block diagram that illustrates more detailed components of a compiler. The compiler includes a front end 210 and back end 220. The front end may comprise several language-specific front ends for performing the syntactic and semantic analysis on source code written in the specific language. For example, the front end may include a Fortran front end 211 and a C++ front end 212. The Fortran front end inputs and processes Fortran source code 201, and the C++ front end inputs and processes C++ source code 202. Each front end outputs an intermediate code representation of the source code in a common intermediate language. The back end includes an inter-procedural analyzer 221, an optimizer 222, and a code generator 223. The inter-procedural analyzer analyzes the intermediate code to, for example, identify sections of unreachable code, identify invoked functions that are candidates for inlining, identify opportunities for strength reductions within a loop, and so on. The inter-procedural analyzer may input code from various libraries 240 to support the inlining. The inter-procedural analyzer outputs analyzed intermediate code that is input by the optimizer. The optimizer performs various optimizations on the analyzed intermediate code such as optimizations specified by the directives to generate optimized intermediate code. The code generator generates assembly code from the optimized intermediate code. An executable generator 230 includes an assembler 231 and a linker 232. The assembler inputs the assembly code and assembles the assembly code into object code. The linker inputs the object code and links the object code to form the executable code. The linker may access the libraries to retrieve and link additional object code to form the executable code. A make command 250 controls the overall processing of the compilation and generation of the executable code. The make command inputs a make file 203, which provides instructions on how to perform the compilation of the source code and the generation of the executable code. The make command interfaces with a driver 260 so that code input by and output by the compiler and the executable generator may be stored in a program library 270.

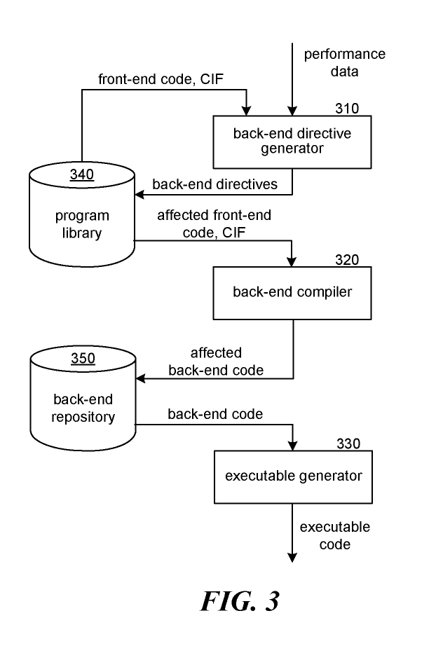

FIG. 3 is a block diagram that illustrates components of an optimization system in some embodiments of the optimization system. The optimization system employs a back-end directive generator 310, a back-end compiler 320, and an executable generator 330. The back-end directive generator inputs performance data for a computer program along with front-end code and compiler information generated during a prior compilation of the computer program. The back-end directive generator analyzes the performance data, the front-end code, and the compiler information to generate back-end directives to direct the back-end compilation of front-end code. A program library 340 stores the front-end code and the compiler information generated during a prior compilation and the back-end directives generated by the back-end directive generator. The back-end compiler inputs front-end code that may be affected by the back-end directives (“affected front-end code”) along with compiler information. “Affected front-end code” is any code that would result in corresponding back-end code different from the last back-end compilation. If the changes in the directives since the last back-end compilation would not cause a change in a certain back-end code module, then that back-end code module would not need to be regenerated. For example, if a newly added directive affects a region of code of a module that invokes a function defined in another module, the back-end compilation may need to be performed on both modules as both modules are affected. However, if the region did not invoke that function, then the other module would not be affected. Also, if the directive was the same as in the last back-end compilation, then neither module would be affected. Because the back-end compilation need only be performed on affected front-end code, the time and computation resources needed to regenerate the executable code are reduced. The back-end compiler generates and stores the regenerated back-end code in a back-end repository 350. The executable generator inputs the back-end code and generates the corresponding executable code. The executable code can then be executed to collect new performance data for the computer program that is provided back into the back-end directive generator to again generate back-end directives and ultimately corresponding executable code without having to regenerate the front-end code of the computer program.

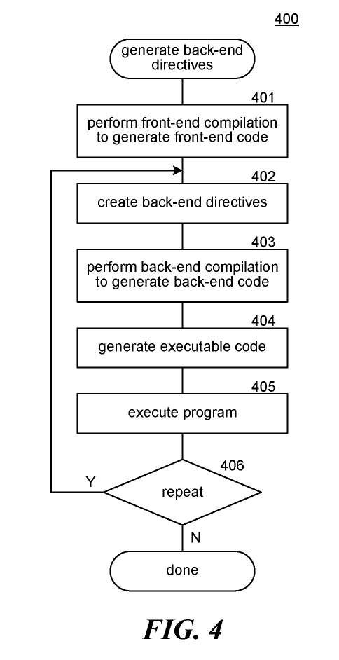

FIG. 4 is a flow diagram that illustrates the processing of a component that controls the generating of back-end directives in some embodiments of the optimization system. A component 400 inputs source code of the computer program, identifies directives for the computer program, and generates executable code in accordance with the directives. In block 401, the component performs front-end compilation of the source code modules to generate front-end code. In block 402, the component creates back-end directives for the computer program. In block 403, the component performs back-end compilation of the front-end code to generate back-end code in accordance with the directives. In block 404, the component generates executable code from the back-end code. In block 405, the component executes the executable code. In decision block 406, if the process of creating the directives should be repeated, then the component loops to block 402, else the component completes. A programmer may specify whether or not to repeat the process based on analysis of performance data. Alternatively, the component may analyze the performance data to determine whether a different optimization level (i.e., higher or lower) should be tried next.

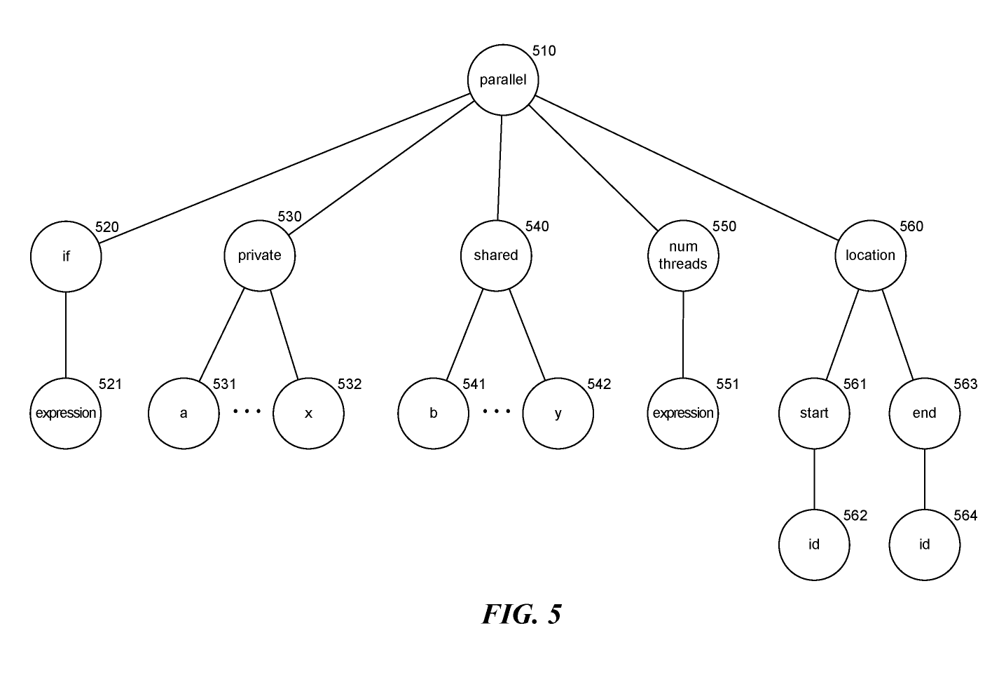

FIG. 5 is a diagram illustrating a representation of a parallel directive in some embodiments of the optimization system. The directives of a compiler may include directives as described in “OpenMP Application Program Interface,” version 4.0, July 2013, published by the OpenMP Architectural Review Board, which is hereby incorporated by reference. Those directive include a parallel directive of the following form:

!$OMP PARALLEL [clause . . . ]
IF (scalar_logical_expression)
PRIVATE (list)
SHARED (list)
DEFAULT (PRIVATE|FIRSTPRIVATE|SHARED|NONE)
FIRSTPRIVATE (list)
REDUCTION (operator: list)
COPYIN (list)
NUM_THREADS (scalar-integer-expression)

{block of code}

!$OMP END PARALLEL

The parallel directive directs that the “block of code” be executed by multiple threads in parallel. One thread is designated as the master thread, which will continue the execution after all the other threads complete. In some embodiments, the optimization system represents directives with a tree data structure with nodes and links between the nodes. Node 510 is the root node and identifies the directive as a parallel directive. Nodes 520, 530, 540, and 550 represent clauses defined for the parallel directive. Node 520 represents an if clause with node 521 specifying the expression of the clause. Node 530 represents a private clause with nodes 531 and 532 identifying the private variables of the block of code. The variables may be identified by identifiers generated by the compiler and provided as part of the compiler information. Node 540 represents a shared clause with nodes 541 and 542 identifying the shared variables of the block of code. Node 550 represents a number of threads clause with node 551 representing the expression for determining the number of threads. Node 560 does not represent a directive clause defined by OpenMP, but it represents a clause that specifies the location(s) within the intermediate code to which the directive applies. Since the parallel directive encloses a block of code, nodes 561 and 563 specify the start and end location of the block of code. Node 562 provides an identifier of the start location, and node 564 provides an identifier of the end location. Although illustrated with a tree data structure, the information of a directive may be represented by a variety of different data organization techniques.

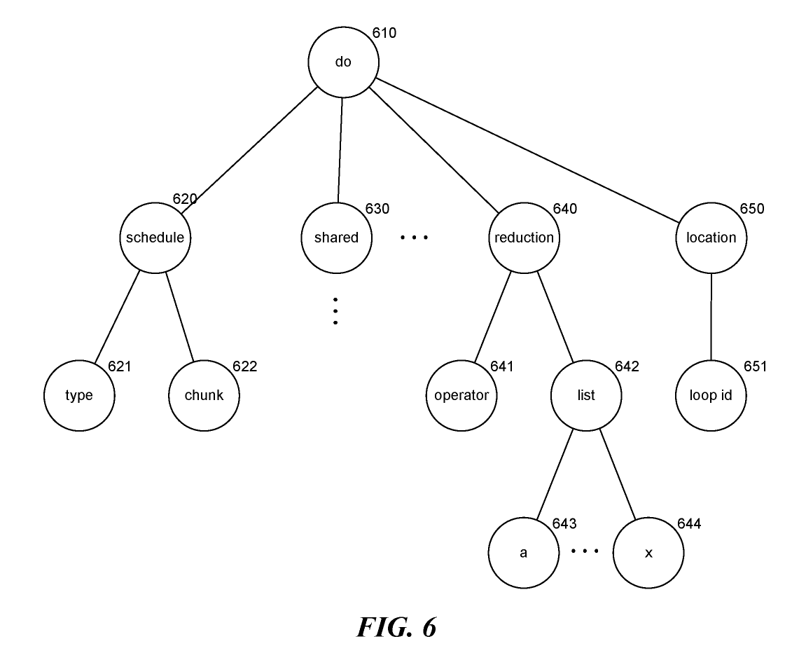

FIG. 6 is a diagram illustrating a representation of a do directive in some embodiments of the optimization system. The do directive has the following form:

!$OMP DO [clause . . . ]
SCHEDULE (type [,chunk])
ORDERED
PRIVATE (list)
FIRSTPRIVATE (list)
LASTPRIVATE (list)
SHARED (list)
REDUCTION (operator|intrinsic:list)
COLLAPSE (n)

{do_loop}

!$OMP END DO [NOWAIT]

The do directive directs that the iterations of a do loop be shared across the threads of a team. Nodes 610-644 define the directive and its clauses. Nodes 650-651 specify the do loop to which the directive applies.

In some embodiments, the directives of a compiler may include directives other than those specified by a standard organization. For example, the developer of a compiler may specify a directive to support parallelization of loops where OpenMP directives are not sufficient to support the parallelization. The following code provides an example of where OpenMP directives are not sufficient to parallelize a loop.

subroutine reduce(n)
do i=1, n
   call my_add(i)
enddo

end subroutine reduce

subroutine my_add(j)
common /my_data/ X, A(10000)
X=X+A(j)

end subroutine my_add

If the loop in the reduce subroutine is to be parallelized, an OpenMP directive is not sufficient because a reduction on variable X would be needed, but variable X is not visible to the reduce subroutine. A non-OpenMP directive may be specified that instructs the compiler to perform an inline substitution of the subroutine invoked by the loop and then to determine the data scoping attributes of the variables. In this case, the variable X would then be visible because of the inlining. The compiler may also generate a copy of the invoked subroutine (e.g., my_add), but modified with atomic memory operations to ensure that each thread retrieves and updates the variable X atomically. When the parallelized code is executed, a thread would be created for each of the n iterations of the loop, and each thread would invoke the modified copy of the my_add subroutine to atomically add A(j) to the variable X. When the threads complete variable X will contain the sum of the first n elements of array A. A compiler developer may specify any number of directives to support different optimization scenarios.

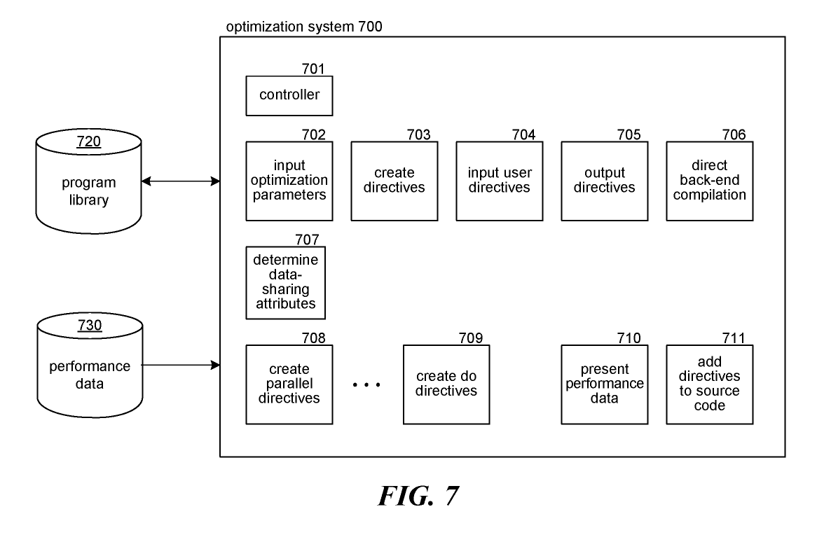

FIG. 7 is a block diagram that illustrates components of the optimization system in some embodiments. The optimization system 700 includes components 701-711 and accesses program library 720 and performance data 730. A controller 701 controls the overall process of generating directives and executable code based on those directives. An input optimization parameters component 702 controls the inputting by a programmer of optimization parameters to specify the level of optimization. The optimization system may include a default set of optimization parameters. In some embodiments, the optimization system may automatically generate sets of optimization parameters in an attempt to identify the set of parameters that results in an optimal performance. For example, the optimization system may employ a technique similar to a numerical analysis optimization technique to find the minimum point (e.g., minimum execution time) of a mathematical function. The optimization system may modify the parameters until they converge on a solution corresponding to a minimum execution time of the computer program. A create directives component 703 creates the directives based on analysis of performance data and intermediate code and source code. An input user directives component 704 receives directives that may be defined by a programmer. An output directives component 705 outputs these directives, for example, using a tree data structure as described above. A direct back-end compilation component 706 directs the back-end compilation of the front-end code of the computer program in accordance with the output directives. The controller may also invoke a determine data-sharing attributes component 707 to determine the data-sharing attributes for the directives. The create directives component may invoke various components to create specific types of directives such as a create parallel directives component 708 and a create do directives component 709. The optimization system may also include a present performance data component 710 to present the performance data to a user to assist the user in controlling the optimization. The optimization system may use an add directives to source code component 711 to actually add the directives (i.e., in a format defined by OpenMP) to the source code. After the directives are added to the source code, a programmer may recompile and generate executable code without, for example, any instrumentation to provide a final version of the computer program.

The computing devices on which the optimization system may be implemented may include a central processing unit, input devices, output devices (e.g., display devices and speakers), storage devices (e.g., memory and disk drives), network interfaces, graphics processing units, and so on. The input devices may include keyboards, pointing devices, touch screens, and so on. The computing devices may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the optimization system. The data transmission media is media for transmitting data using propagated signals or carrier waves (e.g., electromagnetism) via a wire or wireless connection.

The optimization system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the optimization system may be implemented in hardware using, for example, an application-specific integrated circuit (“ASIC”).

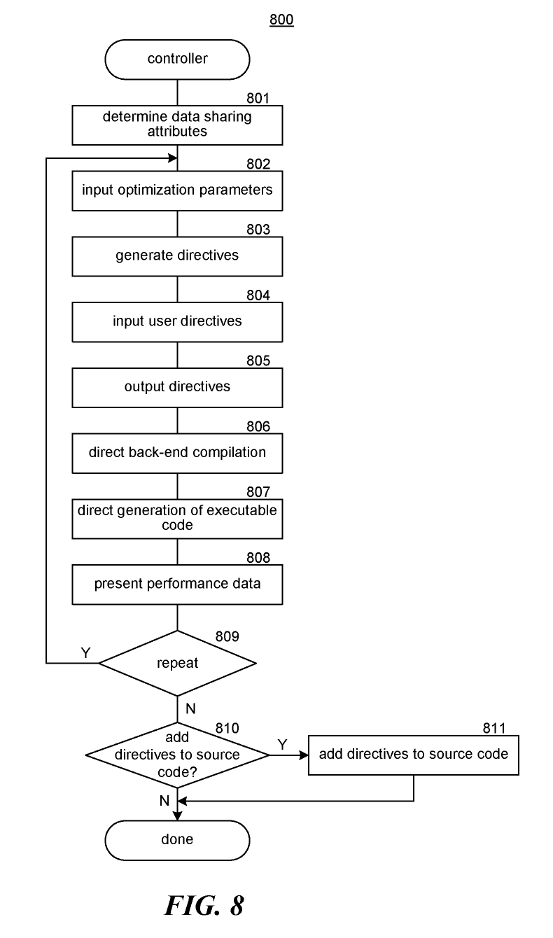

FIG. 8 is a flow diagram that illustrates processing of a controller 800 in some embodiments of the optimization system. In block 801, the controller 800 determines the data-sharing attributes of variables in the computer program. In blocks 802-809, the controller loops generating directives and collecting performance data of executable code generated in accordance with the directives. In block 802, the controller inputs optimization parameters from a user. In block 803, the controller generates directives based on analysis of the optimization parameters, performance data, compiler information, and front-end code. In block 804, the controller inputs additional directives from a user. In block 805, the controller outputs the directives for use during back-end compilation. In block 806, the controller directs the back-end compilation. In block 807, the controller directs the generation of executable code from the back-end code. In block 808, the controller may present the performance data collected during the execution to a programmer. In decision block 809, if the programmer indicates to repeat the process, the controller loops to block 802, else the controller continues at block 810. In decision block 810, if a programmer indicates to add the directives to the source code, then the controller continues at block 811, else the controller completes. In block 811, the controller adds the directives to the source code and then completes.

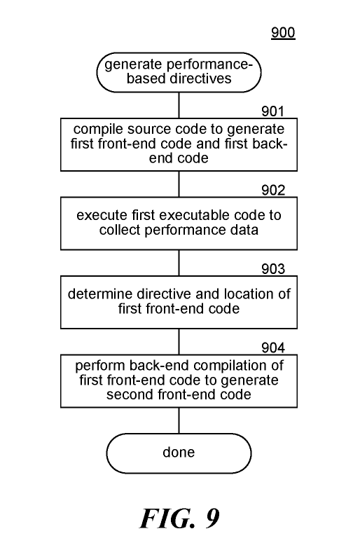

FIG. 9 is a flow diagram that illustrates overall processing of a component to generate performance-based directives in some embodiments of the optimization system. In block 901, the component 900 compiles the source code to generate first front-end code and first back-end code from a first front-end compilation and a first back-end compilation. In block 902, the component executes first executable code corresponding to the first back-end code to collect performance data. In block 903, the component determines a directive and a location within the first front-end code for the directive to be applied based on analysis of the performance data. In block 904, the component performs a second back-end compilation of the first front-end code to generate second front-end code in accordance with the identified directives. The component then completes.

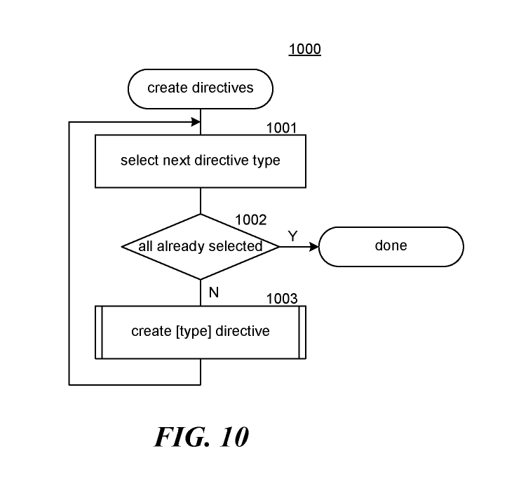

FIG. 10 is a flow diagram that illustrates the processing of a component to create directives in some embodiments of the optimization system. A create directives component 1000 loops selecting each possible directive type and invoking a component specific to that directive type. In block 1001, the component selects the next directive type. In decision block 1002, if all the directive types have already been selected, then the component completes, else the component continues at block 1003. In block 1003, the component invokes a create directive component that is specific to the selected type and then loops to block 1001 to select the next directive type.

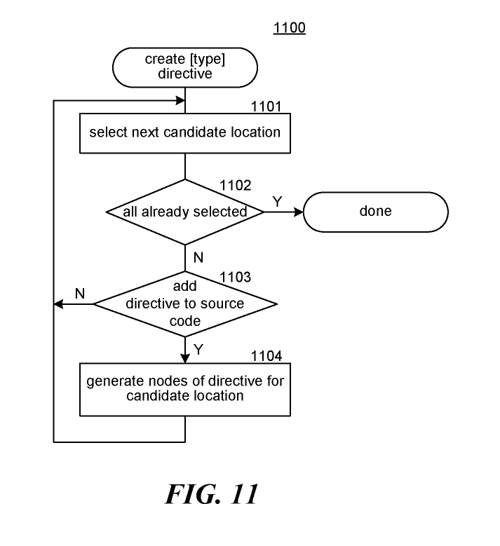

FIG. 11 is a flow diagram that illustrates the processing of a component to create a directive in some embodiments of the optimization system. A component 1100 may loop through candidate locations within the front-end code to identify where to place the directives. The candidate locations, for example, for a do directive may include the start of each do loop. In block 1101, the component selects the next candidate location. In decision block 1102, if all the candidate locations have already been selected, then the component completes, else the component continues at block 1103. In decision block 1103, if a directive criteria is satisfied (e.g. in accordance with the optimization parameters), then the component continues at block 1104, else the component loops to block 1101 to select the next candidate location. In block 1104, the component generates nodes of a tree data structure representing the directive for the selected candidate location and then loops to block 1101 to select the next candidate location.

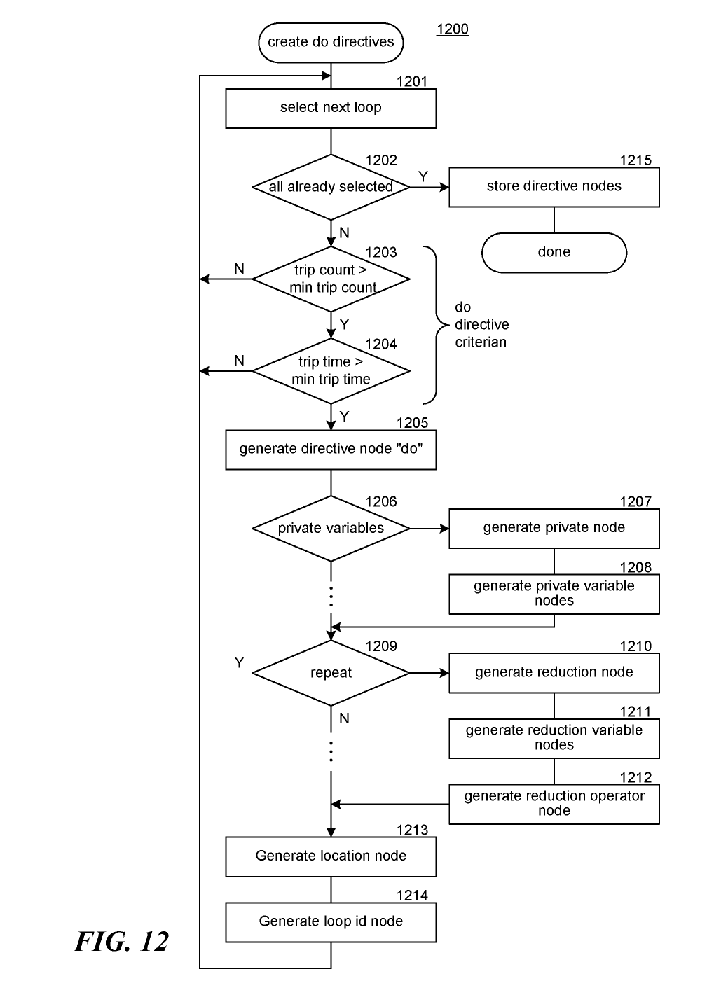

FIG. 12 is a flow diagram that illustrates the processing of a component to create do directives in some embodiments of the optimization system. The component 1200 loops selecting the do loops of a computer program and determines whether a do directive should be applied to each do loop. In block 1201, the component selects the next do loop. In decision block 1202, if all the do loops have already been selected, then the component continues at block 1215, else the component continues at block 1203. In decision block 1203, if a trip count is greater than a minimum specified trip count as indicated by the performance data for the selected do loop, then the component continues at block 1204, else the component loops to block 1201 to select the next do loop. In decision block 1204, if the trip time is greater than a minimum trip time as indicated by the average trip time of the performance data, then the component continues at block 1205, else the component loops to block 1201 to select the next do loop. Decision blocks 1203-1204 implement a do directive criterion indicating whether a do directive should be applied to the selected do loop. In block 1205, the component generates a directive node for the do loop. In decision block 1206, if the do loop has private variables, then the component continues at block 1207, else the component continues at block 1209. In block 1207, the component generates a private node for the data structure. In block 1208, the component generates private variable nodes for each of the variables that are private. In decision block 1209, if a reduction is needed, the component continues at block 1210, else the component continues at block 1213. In block 1210, the component generates a reduction node for the data structure. In block 1211, the component generates reduction variable nodes. In block 1212, the component generates a reduction operator node. In block 1213, the component generates a location node. In block 1214, the component generates a do loop identification node identifying the do loop to which the do directive applies and then loops to block 1201 to select the next do loop.

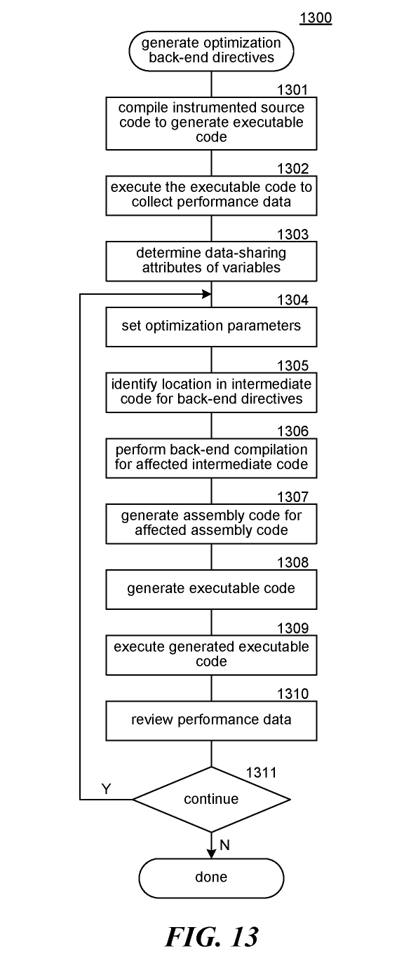

FIG. 13 is a flow diagram that illustrates processing of a component to generate back-end directives in some embodiments of the optimization system. In block 1301, the component 1300 compiles instrumented source code of a computer program to generate front-end code, back-end code, and instrumented executable code. In block 1302, the component executes the executable code to collect performance data. In block 1303, the component determines the data-sharing attributes of the variables of the computer program. In blocks 1304-1311, the component loops executing executable code generated using different directives. In block 1304, the component sets the optimization parameters. In block 1305, the component identifies back-end directives for locations within intermediate code. In block 1306, the component performs back-end compilation of the front-end code affected by the back-end directives to generate assembly code. In block 1307, the component generates object code corresponding to the assembly code. In block 1308, the component generates executable code by linking the object code. In block 1309, the component executes the executable code to generate performance data for the computer program with the directives. In block 1310, the component analyzes the performance data. In decision block 1311, if continued optimization is needed, the component loops to block 1304, else the component completes.

The following paragraphs describe various embodiments of aspects of the optimization system. An implementation of an optimization system may employ any combination of the embodiments. The processing described below may be performed by a computing device with a processor that executes computer-executable instructions stored on a computer-readable storage medium that implements the optimization system.

In some embodiments, a method performed by a computer is provided. The method performs compilation of source code of a program to generate first front-end code and first back-end code of the program. The compilation includes first front-end compilation and first back-end compilation. The method executes first executable code corresponding to the first back-end code to collect first performance data on the program. The method determines, based on analysis of the first performance data and the program, a directive to apply to a location within the first front-end code. The method also performs second back-end compilation of the first front-end code factoring in the directive to generate second back-end code affected by the directive. In some embodiments, the performing of the second back-end compilation does not regenerate second back-end code that would be the same as the corresponding first back-end code. In some embodiments, the back-end code is assembly code. In some embodiments, the back-end code is object code. In some embodiments, the method further comprises generating second executable code corresponding to the second back-end code. In some embodiments, the generating of second executable code includes assembling the second back-end code into object code and linking the object code. In some embodiments, the method further comprises executing the second executable code to collect second performance data on the program; determining, based on analysis of the second performance data and the program, a directive to apply to a location within the first front-end code; and performing third back-end compilation of the first front-end code factoring in the directive to generate third back-end code affected by the directive. In some embodiments, the method further comprises, prior to determining a directive, determining data-sharing attributes of variables of the program based on analysis of the program with invoked functions inlined. In some embodiments, the directive specifies a data-sharing attribute of a variable of the program. In some embodiments, the source code is instrumented for collecting performance data. In some embodiments, the method further comprises maintaining a program library that stores front-end code and compiler information for mapping front-end code to corresponding source code. In some embodiments, the directive supports optimization of the program during back-end compilation and the method further comprises receiving from a user an indication of an optimization parameter for controlling the optimization.

In some embodiments, a computing system for generating an optimized version of a program is provided. The computing system comprises a computer-readable storage medium storing computer-executable instructions. The computer-executable instructions include instructions that access performance data of the program. The computer-executable instructions include instructions that access a mapping of front-end code to source code of the program wherein the front-end code is generated during front-end compilation of the source code. The computer-executable instructions include instructions that determine data-sharing attributes of variables of the program. The computer-executable instructions include instructions that analyze the performance data, the data-sharing attributes, the mapping, and the program to determine directives to apply to locations within the front-end cod. The computer-executable instructions include instructions that direct back-end compilation of the front-end code of the program based on the directives applied to the location within the front-end code. The computing system further comprises a processor for executing the computer-executable instructions stored in the computer-readable storage medium. In some embodiments, the back-end compilation generates back-end code and the computer-executable instructions further include instructions that direct assembly and linking of the back-end code to generate executable code. In some embodiments, the computer-executable instructions further include instructions that determine the data-sharing attributes based on analysis of the program with invoked functions inlined. In some embodiments, the instructions that direct the back-end compilation direct the compilation of only front-end code affected by the directives. In some embodiments, the front-end code whose back-end compilation is directed is not generated based on source code that includes the directives.

In some embodiments, a computer-readable storage medium storing computer-executable instructions for controlling a computer is provided. The instructions comprise instructions that compile source code of a program to generate first intermediate code and first executable code of the program. The instructions further comprise instructions that direct execution of the first executable code to collect first performance data on the program. The instructions further comprise instructions that determine, based on analysis of the first performance data and the program, a directive to apply to a location within the first intermediate code. The instructions further comprise instructions that compile the first intermediate code into second executable code factoring in the directive applied to the location. In some embodiments, the instructions further comprise instructions that, after execution of the second executable code, insert the directive into the source code. In some embodiments, the instructions further comprise instructions that analyze the program with invoked functions inlined to determine a data-sharing attribute of a variable of the program, wherein the directive is based on the data-sharing attribute.

In some embodiments, a method performed by a computer is provided. The method performs first compilation of source code of a program to generate first front-end code and first back-end code of the program. The compilation includes a first front-end compilation and a first back-end compilation. The method determines a directive to apply to a location within the first front-end code. The method performs a second back-end compilation of the first front-end code factoring in the directive to generate second back-end code affected by the directive. In some embodiments, the determining of the directive includes receiving from a user an indication of the directive and the location. In some embodiments, the method further comprises analyzing performance data collected during execution of the program and wherein the determining of the directive is based on the analysis. In some embodiments, the performing of the second back-end compilation does not regenerate second back-end code that would be the same as the corresponding first back-end code. In some embodiments, the back-end code is assembly code. In some embodiments, the back-end code is object code. In some embodiments, the method further comprises generating first executable code corresponding to the first back-end code and generating second executable code corresponding to the second back-end code. In some embodiments, the generating of executable code includes assembling back-end code into object code and linking the object code. In some embodiments, the method further comprises determining a second directive to apply to a location within the first front-end code and performing third back-end compilation of the first front-end code factoring in the second directive to generate second back-end code affected by the directive.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computer, the method comprising:
performing compilation of source code of a program to generate first front-end code and first back-end code of the program, the compilation including first front-end compilation and first back-end compilation;
executing first executable code corresponding to the first back-end code to collect first performance data on the program;
determining, based on analysis of the first performance data and the program, a directive to apply to a location within the first front-end code; and
performing second back-end compilation of the first front-end code factoring in the directive to generate second back-end code affected by the directive.

2. The method of claim 1 wherein the performing of the second back-end compilation does not regenerate second back-end code that would be the same as the corresponding first back-end code.

3. The method of claim 1 wherein back-end code is assembly code.

4. The method of claim 1 wherein back-end code is object code.

5. The method of claim 1 further comprising generating second executable code corresponding to the second back-end code.

6. The method of claim 5 wherein the generating of second executable code includes assembling the second back-end code into object code and linking the object code.

7. The method of claim 5 further comprising:
executing the second executable code to collect second performance data on the program;
determining, based on analysis of the second performance data and the program, a directive to apply to a location within the first front-end code; and
performing third back-end compilation of the first front-end code factoring in the directive to generate third back-end code affected by the directive.

8. The method of claim 1 further comprising, prior to determining a directive, determining data-sharing attributes of variables of the program based on analysis of the program with invoked functions inlined.

9. The method of claim 8 wherein the directive specifies a data-sharing attribute of a variable of the program.

10. The method of claim 1 wherein the source code is instrumented for collecting performance data.

11. The method of claim 1 further comprising maintaining a program library that stores front-end code and compiler information for mapping front-end code to corresponding source code.

12. The method of claim 1 wherein the directive supports optimization of the program during back-end compilation and further comprising receiving from a user an indication of an optimization parameter for controlling the optimization.

13. A computing system for generating an optimized version of a program, the computing system comprising:
a computer-readable storage medium storing computer-executable instructions that include:
instructions that access performance data of the program;
instructions that access a mapping of front-end code to source code of the program, the front-end code generated during front-end compilation of the source code;
instructions that determine data-sharing attributes of variables of the program;
instructions that analyze the performance data, the data-sharing attributes, the mapping, and the program to determine directives to apply to locations within the front-end code; and
instructions that direct back-end compilation of the front-end code of the program based on the directives applied to the location within the front-end code; and
a processor for executing the computer-executable instructions stored in the computer-readable storage medium.

14. The computing system of claim 13 wherein the back-end compilation generates back-end code and wherein the computer-executable instructions further include instructions that direct assembly and linking of the back-end code to generate executable code.

15. The computing system of claim 13 wherein the computer-executable instructions further include instructions that determine the data-sharing attributes based on analysis of the program with invoked functions inlined.

16. The computing system of claim 13 wherein the instructions that direct the back-end compilation direct the compilation of only front-end code affected by the directives.

17. The computing system of claim 13 wherein the front-end code whose back-end compilation is directed is not generated based on source code that includes the directives.

18. A computer-readable storage medium storing computer-executable instructions for controlling a computer, the instructions comprising:
instructions that compile source code of a program to generate first intermediate code and first executable code of the program;
instructions that direct execution of the first executable code to collect first performance data on the program;
instructions that determine, based on analysis of the first performance data and the program, a directive to apply to a location within the first intermediate code; and
instructions that compile the first intermediate code into second executable code factoring in the directive applied to the location.

19. The computer-readable storage medium of claim 18 further comprising instructions that, after execution of the second executable code, insert the directive into the source code.

20. The computer-readable storage medium of claim 18 further comprising instructions that analyze the program with invoked functions inlined to determine a data-sharing attribute of a variable of the program, wherein the directive is based on the data-sharing attribute.

21. A method performed by a computer, the method comprising:
performing a first compilation of source code of a program to generate first front-end code and first back-end code of the program, the compilation including a first front-end compilation and a first back-end compilation;
determining a directive to apply to a location within the first front-end code; and
performing a second back-end compilation of the first front-end code factoring in the directive to generate second back-end code affected by the directive.

22. The method of claim 21 wherein the determining of the directive includes receiving from a user an indication of the directive and the location.

23. The method of claim 21 further comprising analyzing performance data collected during execution of the program and wherein the determining of the directive is based on the analysis.

24. The method of claim 21 wherein the performing of the second back-end compilation does not regenerate second back-end code that would be the same as the corresponding first back-end code.

25. The method of claim 21 wherein back-end code is assembly code.

26. The method of claim 21 wherein back-end code is object code.

27. The method of claim 21 further comprising generating first executable code corresponding to the first back-end code and generating second executable code corresponding to the second back-end code.

28. The method of claim 27 wherein the generating of executable code includes assembling back-end code into object code and linking the object code.

29. The method of claim 21 further comprising:
determining a second directive to apply to a location within the first front-end code; and
performing third back-end compilation of the first front-end code factoring in the second directive to generate second back-end code affected by the directive.
